(19) United States
(12) Patent Application Publication
(10) Pub. No.: US 2006/0176582 A1
(43) Pub. Date: Aug. 10, 2006

(54) Refrigerator magnet with a magnifying apparatus

(75) Inventor: Scott L. Amron, Nesconset, NY (US)

Correspondence Address: Alfred W. Froebrich, Esq.;Cohen, Pontani, Lieberman & Pavane, Suite 1210, 551 Fifth Avenue, New York, NY, 10176, US

(73) Assignee: THUNK IT, LLC

(21) Appl. No.: 11/351,613

(22) Filed: Feb. 9, 2006

Related U.S. Application Data
(60) Provisional application No. 60/651,387, filed on Feb. 9, 2005.

(51) Int. Cl. G02B 27/02

(52) U.S. Cl. 359/802

(57) ABSTRACT

A magnetic magnifying apparatus for magnifying and highlighting a portion of a document held beneath said magnetic magnifying apparatus includes a lens having a top surface, a bottom surface, and a periphery. A frame surrounds the periphery of the lens and holds the lens relative to the frame such that the portion of the document beneath the magnetic magnifying apparatus is magnified when viewed through the lens. The apparatus further comprises a magnet arranged in a recess defined in a bottom surface of the frame for securing the apparatus and the document to an underlying magnetically attractive surface.

### CROSS REFERENCE TO RELATED APPLICATIONS

This application claims priority from U.S. Provisional Patent Application Ser. No. 60/651,387 which was filed on Feb. 9, 2005.

### BACKGROUND OF THE INVENTION

The present invention relates to a magnetic magnifying apparatus which is used to hold paper memos, documents, notices, photos, and similar thin sheet materials against flat or rounded, usually vertically oriented, magnetically attractive surfaces. The magnetic magnifying apparatus of the present invention is adapted to magnify or enlarge the portion of the document or surface over which it is placed for the purposes of highlighting the magnified portion.

Refrigerator magnets are generally used to secure documents to a refrigerator door or other magnetically attractive surface. These magnetic devices are placed on top of a document to be secured to the magnetically attractive surface and typically occlude a view of at least a part of the document being held. Furthermore, these known magnetic devices lack the ability to highlight and magnify important portions of the secured document.

Magnifying apparatus which are used to improve the readability of cookbooks, photos, memos, newspapers, postcards, letters and the like do not store easily. They are often stored in cluttered kitchen drawers and are not easily available when they are needed.

### SUMMARY OF THE INVENTION

An object of the present invention is to provide a magnetic magnifying apparatus that overcomes the problems associated with the prior art.

The object is met by a magnetic magnifying apparatus for holding thin non-magnetic sheet materials against a flat or semi-flat, magnetically attractive surface including an optical lens for highlighting or magnifying the portion of the document or surface over which the magnetic device is placed. The magnetic magnifying apparatus includes at least one magnet for magnetic attachment to a magnetically attractive surface, and a frame holding the magnet and lens.

The magnetic magnifying apparatus enables a user to secure a document and highlight important portions of the document with the same magnetic device. Thus, the device of the present invention functions as both a magnetic pushpin for holding a document on the magnetically attractive surface and a magnifying apparatus for highlighting or magnifying the portion of the document or surface over which the magnetic device is placed. The magnetic magnifying apparatus may also be used to magnify cookbooks and other printed materials for an improved viewing and reading experience and may be stored on any magnetically attractive surface such as a refrigerator door or message board.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like reference characters denote similar elements throughout the several views:

FIG. 1 is a perspective view of a top and a side of a magnetic magnifying apparatus according to an embodiment of the present invention;

FIG. 2 is a perspective view of a bottom and side of the magnetic magnifying apparatus of FIG. 1;

FIG. 3 is a cross-sectional exploded view of the magnetic magnifying apparatus of FIG. 1;

FIG. 4 is a plan view of a top of a magnetic magnifying apparatus according to a further embodiment of the present invention;

FIG. 5 is a sectional view of a magnetic magnifying apparatus according to another embodiment according to the present invention;

FIG. 6 is a sectional view of a frame of the magnetic magnifying apparatus of FIG. 5;

FIG. 7 is a bottom view of the frame of FIG. 6;

FIG. 8 is a perspective view of a top and side of a lens of the magnetic magnifying apparatus of FIG. 5;

FIG. 9 is a cross-sectional view of the lens of FIG. 8;

FIG. 10 is a cross-sectional view of another embodiment of a magnetic magnifying apparatus according to the present invention;

FIG. 11 is a cross-sectional view of yet another embodiment of a magnetic magnifying apparatus according to the present invention;

FIG. 12 is a view of the magnetic magnifying apparatus of FIG. 1 arranged on a refrigerator;

FIG. 13 is a cross-sectional view of a frame according to a further embodiment;

FIG. 14 is a cross-sectional view of a magnetic magnifying apparatus incorporating a light and an associated circuit; and

FIG. 15 is a schematic diagram of the light circuit from the apparatus of FIG. 14.

### DETAILED DESCRIPTION OF THE PRESENTLY PREFERRED EMBODIMENTS

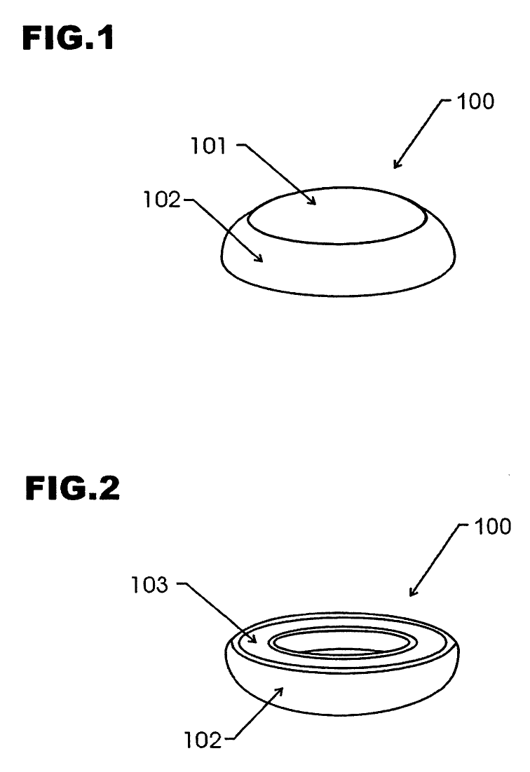

FIGS. 1-3 show a magnetic magnifying apparatus 100 constructed according to an embodiment of the present invention. The magnetic magnifying apparatus 100 includes a frame 102, a circular lens 101 mounted in frame 102, and a ring-shaped magnet 103 arranged in an annular recess 104 in the bottom of frame 102. To achieve a lightweight low cost final product, the lens 101 can be made of a variety of polymers such as Acrylic (PMMA), Polycarbonate (PC), Polystyrene (PS), as well as newer materials such as Cyclic Olefin Copolymer (COC), Amorphous Polyolefin (Zeonex), and saturated polyester. Although this embodiment describes the use of a polymer lens, a lens made of glass or any other lens material known or hereafter developed may alternatively be used. The lens 101 is preferably an aspherical lens such as, for example, the 5228 aspheric polymer lens from G-S PLASTIC OPTICS of Rochester, N.Y. An aspherical lens is chosen for its ability to correct for distortion. In contrast, spherical lenses cause a distorted image. Although aspherical lenses are used in the preferred embodiment, spherical lenses may alternatively be used. The lens 101 is depicted as a “plano-convex” lens and is arranged for the magnification of items placed beneath the magnetic magnifying apparatus 100. A filter or coating may optionally be added to improve the optical characteristics of the lens such as, for example, mirror coatings, anti-fog coatings, and coatings to improve abrasion resistance and minimize reflections and glare.

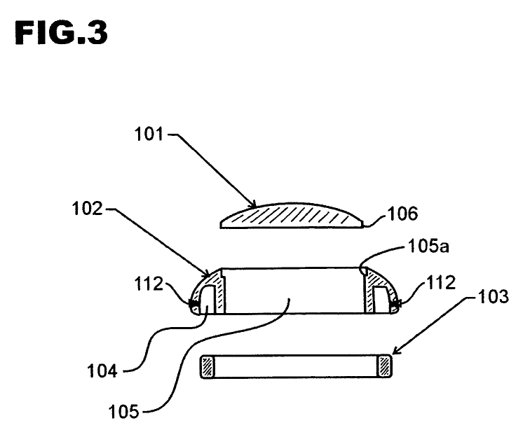

FIGS. 2 and 3 show the ring magnet 103 and the annular recess 104 of the frame 102. The ring magnet 103 comprises, for example, the CR162 ceramic ring magnet from Master Magnetics, Inc., of Castle Rock, Colo. The magnet 103 is embedded in the annular recess in the bottom of the frame 102 and may be secured by glue, adhesive. The magnet 103 may alternatively or additionally be held in the annular recess 104 using set screws 112 arranged through the sides of frame 102, or any other fastening means known or hereafter developed. The ring magnet 103 is included to provide for magnetic attachment of the frame to a magnetically attractive substrate.

The frame 102 may be made of wood, plastic, metal, rubber, transparent plastic material, or any other material known or hereafter developed which is sufficiently strong enough to support the lens 101. A frame made of transparent plastic material would permit more light to pass through the frame, further improving the viewing experience. As shown in FIG. 3, the center aperture 105 of frame 102 includes a shoulder 105a which support the edge 106 of the lens 101. The lens 101 may be held in frame 102 using an adhesive, glue, interference fit or other known or hereafter developed material or technique.

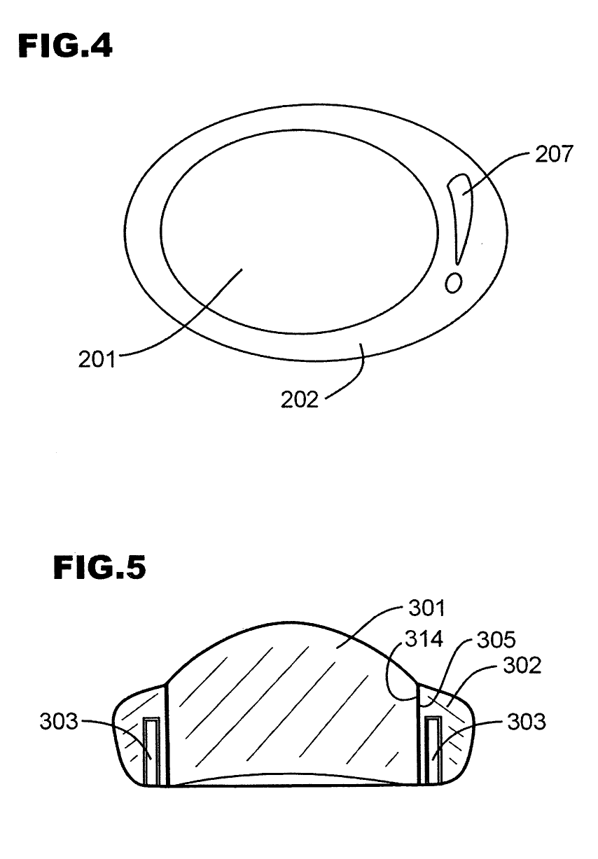

The magnetic magnifying apparatus is depicted as being circular in FIGS. 1-3. However, the magnetic magnifying apparatus may comprise any shape such as, for example, elliptical, rectangular, or square. FIG. 4 shows an alternative embodiment in which an oval-shaped lens 201 is arranged in an oval-shaped frame 202. Furthermore, an indication 207 is arranged on the frame 202. The indication 207 comprises an exclamation point in FIG. 4. However, the indication 207 may comprise any other shape such as, for example, an arrow pointing to the magnified subject matter. The indication 207 may be printed or painted or otherwise applied onto the frame 202. Alternatively, or additionally, the indication 207 may be embossed on or cut out of the surface of the frame 202.

FIGS. 5-9 show a further embodiment of a magnetic magnifying apparatus 300 including a lens 301, a frame 302, and a plurality of magnets 303. In this embodiment, the magnets 303 comprise cylindrical neodymium magnets having a diameter of approximately 4mm and a length of approximately 13 mm or ½ inch. Although cylindrical magnets are used in the embodiment of FIGS. 5-9, the magnets may comprise any shape. In addition, the magnets 303 may be nickel-plated. Although FIG. 7 shows that four magnets 303 are used, any number of magnets may be used. To maximize the magnetic attraction, the bottom of the magnets 303 should be flush with the bottom of the frame 302.

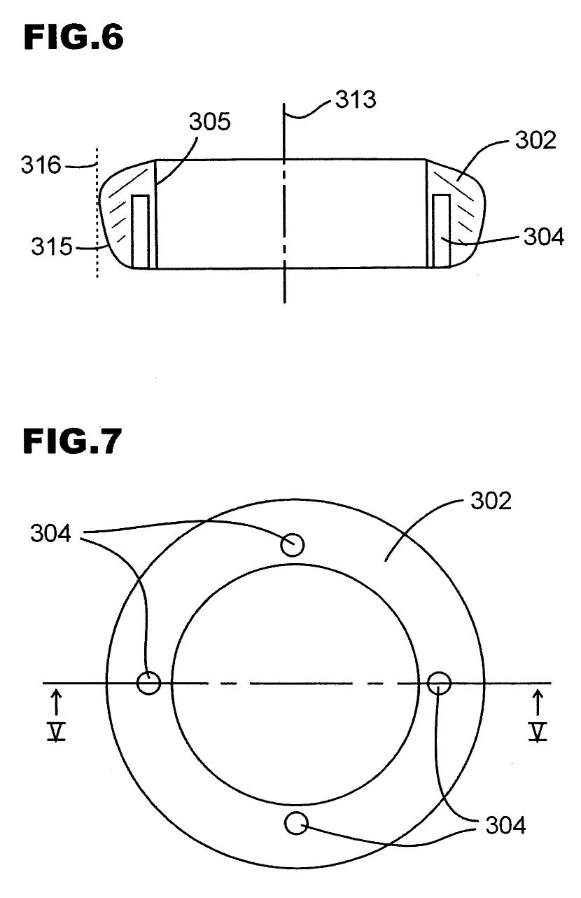

The frame 302 of the magnetic magnifying apparatus 300 is shown in FIGS. 6 and 7. The frame 302 is ring-shaped and has a cylindrical inner circumferential surface 305 with a central longitudinal axis 313. The frame 302 also includes recesses 304 in the bottom surface, each receiving one of the magnets 303. The recesses preferably extend substantially parallel to the longitudinal axis 313. The outer sides 315 of frame 302 taper radially inward from the top end to the bottom end of the frame as shown in FIG. 6. The tapered sides 315 facilitate handling of the magnetic magnifying apparatus 300. In the embodiment of FIGS. 5-9, the frame 302 is preferably made of silicone rubber to compensate for any out-of-roundness of the lens 301 which can be inexpensively made as, for example, a molded saturated polyester lens.

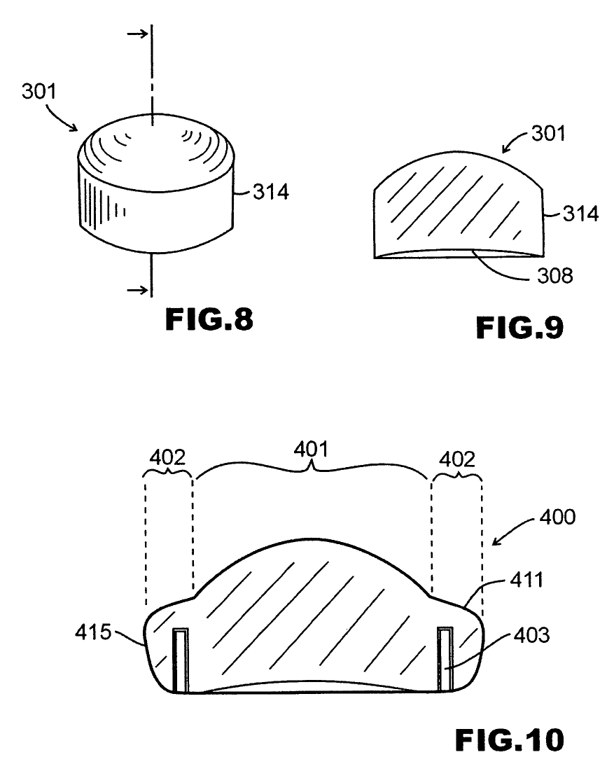

FIGS. 8 and 9 show the lens 301 according to the present embodiment. The lens 301 is a Meniscus lens and is thicker than the lens 101 of the embodiment in FIGS. 1-3. The Meniscus lens 301 adds optical efficiency by adding power with the concavity of the lower service (the concavity is described in more detail below). The Meniscus lens also improves lighting of the magnified subject matter compared to the thinner lens of the embodiment of FIGS. 1-3 by providing a “light gathering” effect. Furthermore, the meniscus lens 301 has an infinite eyepoint, wherein a viewer's eye can be any distance from the lens 301 and at a wide angle without adverse effects on focus or clarity. The lens 301 has a cylindrical outer surface 314 which is sufficiently dimensioned to create an interference fit or friction fit with the surface 305 of the frame 302. More specifically, the circumference of surface 305 is slightly smaller than the circumference of the lens 301 so that the frame 302 stretches when the lens 301 is inserted therein, whereby an interference fit or friction fit capable of retaining the lens in the frame 302 is produced. Similarly, the magnets 303 may stretch the recesses 304 when they are inserted to produce a friction fit or interference fit for retaining the magnets in the frame 302. Alternatively or additionally, a glue or adhesive may be used to hold the lens 301 in the frame 302.

The lens 301 further comprises a concave bottom 308. This allows the magnetic magnifying apparatus to be attached to curved surfaces such as, for example, metallic desk lamps or other metallic lamp covers or shields. Furthermore, the concave bottom 308 provides adequate clearance for magnification and prevent the occurrence of smudges and scratches on the bottom of the lens 301. Alternatively, lens 301 may comprise a piano-convex lens having a flat bottom.

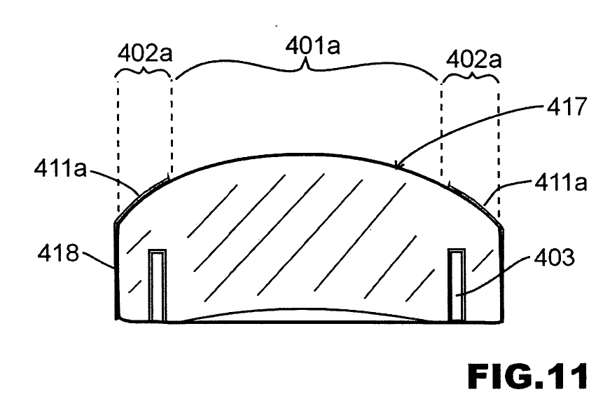

In further embodiments of a magnetic magnifying apparatus 400, 400a shown in FIGS. 10 and 11, a lens portion 401, 401a and frame portion 402, 402a are molded as a single continuous integral piece. In FIG. 10, the external surface of frame portion 402 has an external shape similar to the that shown in FIGS. 1-3 and 5-9. A coating or layer 411 such as a frosted glass, layer of paint or other colored covering may be added on the frame portion 402 to indicate where the magnifying apparatus may be handled and/or for a decorative effect. The frame portion 402 of magnetic magnifying apparatus 400 also includes tapered sides 415 similar to the tapered sides 315 of the magnetic magnifying apparatus 300 of FIGS. 5-9.

FIG. 11 shows an embodiment in which the lens portion 401a and the frame portion 402a are part of a single continuous curved surface 417. A cover 411a may be arranged over the frame portion 402a of the surface 417. The sides 418 of the magnetic magnifying apparatus 400a are shown as being substantially cylindrical. However, the magnetic magnifying apparatus 400a may also include tapered sides 415 as shown in FIG. 10.

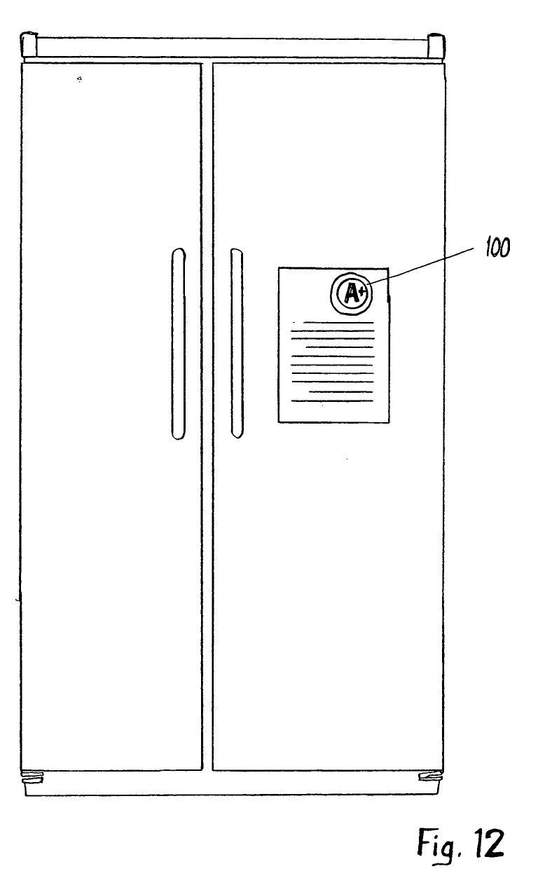

FIG. 12 shows an example of the magnifying apparatus 100, 300, 400, 400a in use holding a paper on a refrigerator.

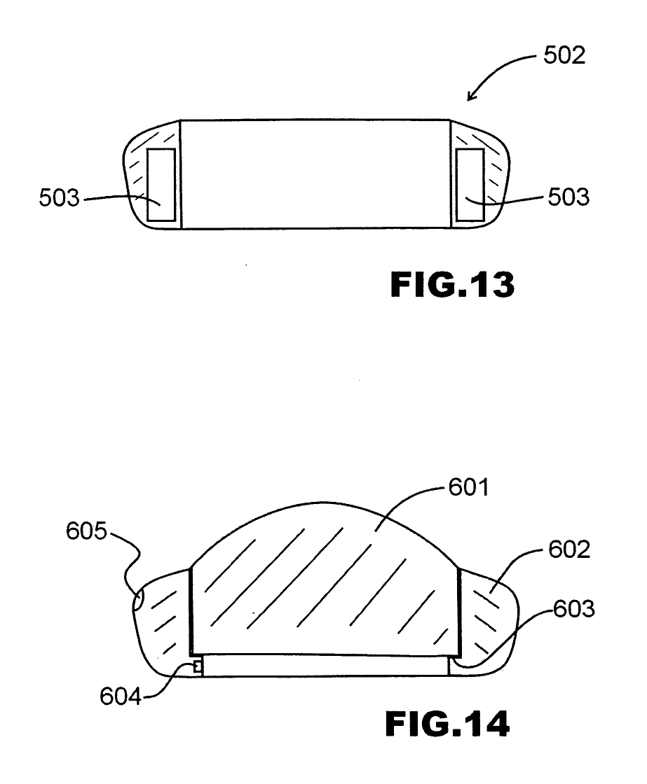

FIG. 13 shows a further embodiment of a frame 502 according to the present invention in which a magnet 503 is embedded. In this embodiment, the magnet 503 may comprise magnets similar to the cylindrical magnets 303 or the ring magnet 103 described above. The frame 502 may comprise a shoulder for holding a plano-convex lens 101 or the inward facing sides arranged for holding the meniscus lens 301 described above.

FIG. 14 discloses yet another magnetic magnifying apparatus 600 having a lens 601 which may comprise any of the above described lenses. A frame 602 includes magnets 603 using any of the above described magnets 103, 303, 403, 503. The frame 602 also incorporates an LED light 604 and an electrode 605 which are part of a circuit which is embedded in the frame 602.

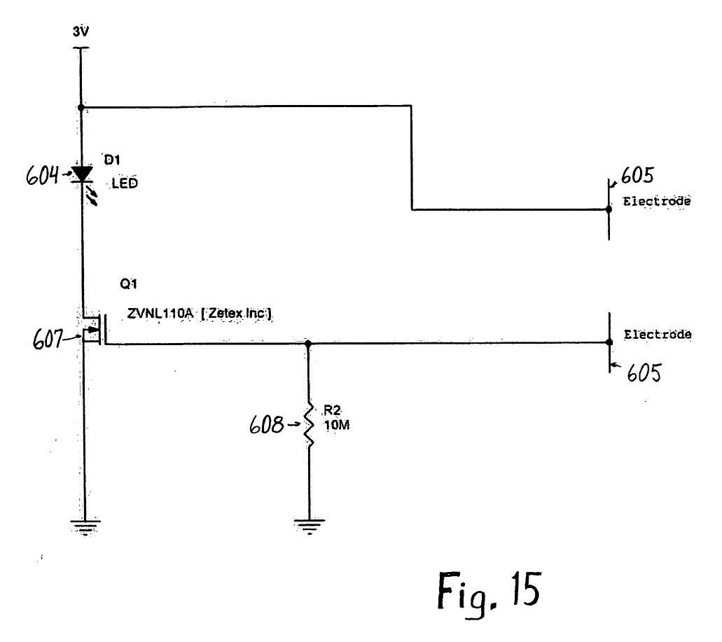

FIG. 15 further shows the circuit which may be incorporated into the magnetic magnifying device of FIG. 14 to light or highlight the area to be magnified. The circuit comprises a touch activated LED circuit employing a MOSFET 607 (ZVNL110A made by Zetex, Inc.), a 10M ohm resistor 608 and an LED 604. The electrodes 605 may be part of a capacitive proximity switch such as the Charge-Transfer (Sense Field) Touch Switch circuit employing the QT110 Touch Sensor IC made by Quantum Research Group may be used to trigger the LED. The benefit of the capacitive proximity switch is to increase the touch sensitive surface area and insulate the user from contact with metal electrodes. A power source may comprise a battery arranged in the frame or an inductively charged device.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A magnetic magnifying apparatus for magnifying and highlighting a portion of a document held beneath said magnetic magnifying apparatus, comprising:
a lens having a top surface, a bottom surface, and a periphery;
a frame surrounding said periphery of said lens and holding said lens relative to said frame such that the portion of the document held beneath said magnetic magnifying apparatus is magnified when viewed through said lens, said frame having a top end and a bottom end; and
a magnet arranged in said frame for securing said apparatus and an intervening document to an underlying magnetically attractive surface.

2. The apparatus of claim 1, further comprising a plurality of magnets arranged in respective recesses in said frame, each of said magnets comprises a cylindrical magnet having a longitudinal axis and two opposing ends, wherein one of said ends is approximately flush with said bottom of said frame and said longitudinal axis of said each cylindrical magnet is approximately normal to a plane defined by a bottom surface of said frame.

3. The apparatus of claim 2, wherein said frame is made of silicone rubber and comprises an inward facing surface facing said periphery of said lens.

4. The apparatus of claim 3, wherein said inward facing surface is dimensioned so that said lens is held in said frame by a friction fit between said inward facing surface and said periphery of said lens.

5. The apparatus of claim 4, wherein said magnets are held in said recesses by a friction fit.

6. The apparatus of claim 3, wherein said magnets are held in said recesses by a friction fit.

7. The apparatus of claim 3, wherein said inward facing surface has a height and said lens comprises a peripheral surface having a lens height corresponding approximately to said height of said inward facing surface.

8. The apparatus of claim 7, wherein said internal surface is dimensioned so that said periphery of said lens is held by a friction fit.

9. The apparatus of claim 7, wherein said bottom of said lens is concave, thereby allowing attachment of said apparatus to a curved magnetically attractive surface.

10. The apparatus of claim 1, wherein said bottom of said lens is concave, thereby allowing attachment of said apparatus to a curved magnetically attractive surface.

11. The apparatus of claim 1 further comprising an indicia arranged on said frame.

12. The apparatus of claim 1, wherein said lens and said frame are integrally molded as a single continuous piece.

13. The apparatus of claim 12, wherein a top surface of said frame and said top surface of said lens comprise portions of a continuous uninterrupted curved surface.

14. The apparatus of claim 12, wherein the external surface of said frame is one of frosted or colored.

15. The apparatus of claim 1, wherein said frame includes outer sides facing away from said periphery of said lens, said outer sides tapering inward from said top end to said bottom end of said frame, thereby facilitating handling of said apparatus.

16. The apparatus of claim 1, wherein said lens is arranged and dimensioned for increasing a brightness of the portion of the document beneath the lens for a viewer in front of said apparatus.

17. The apparatus of claim 1, wherein said magnet is arranged in a recess in a bottom of said frame.

18. The apparatus of claim 1, wherein said magnet is embedded in said frame.

19. The apparatus of claim 1, further comprising a circuit arranged in said frame having a light and a touch sensitive switch actuatable for activating said light.

20. A magnetic magnifying apparatus for magnifying and highlighting a portion of a document held beneath said magnetic magnifying apparatus, comprising:
a lens having a top surface, a bottom surface, and a peripheral surface;
a frame made of a stretchable material defining an aperture for receiving said lens, said aperture being defined by an inward facing surface of said frame, wherein a circumference of said aperture in a relaxed state of said frame is smaller than a circumference of said peripheral surface, said aperture of said frame being expanded when said lens is received in said frame and creating one of a friction fit or an interference fit sufficient for retaining said lens in said frame; and
a magnet arranged in a recess defined in a bottom surface of said frame for securing said apparatus and an intervening document to an underlying magnetically attractive surface, said recess being arranged and dimensioned such that said recess expands from a relaxed state when said magnet is received in said recess creating one of a friction fit or an interference fit sufficient for retaining said magnet in said frame.

21. The apparatus of claim 20, wherein said frame is made of silicone rubber.

22. The apparatus of claim 20, further comprising a plurality of magnets arranged in respective recesses in said frame, each of said magnets comprises a cylindrical neodymium magnet having a longitudinal axis and two opposing ends inserted lengthwise into said respective recesses.

23. The apparatus of claim 20, wherein said frame comprises a bottom end defining a plane, said peripheral surface of said lens and said inward facing surface of said frame extend approximately normal to said plane.

24. A method of using a magnetic magnifying apparatus for magnifying and highlighting a portion of a document, the magnetic magnifying apparatus, comprising a lens having a top surface, a bottom surface, and a periphery, a frame surrounding the periphery of the lens and holding the lens relative to the frame such that the portion of the document beneath the magnetic magnifying apparatus is magnified when viewed through the lens, and a magnet arranged in a recess defined in a bottom surface of the frame for securing the apparatus and an intervening document to an underlying magnetically attractive surface, said method comprising the steps of:
placing the magnetic magnifying apparatus on a document to be magnified; and
storing the magnetic magnifying apparatus on a magnetically attractive surface.
